(19) United States
(12) Patent Application Publication
(10) Pub. No.: US 2007/0291584 A1
(43) Pub. Date: Dec. 20, 2007

(54) Shaking mixer

(75) Inventors: Yi-Lung Lee, Taichung County (TW); Chin-Sung Lin, Taichung County (TW); Zhen-Hua Chou, Hualien County (TW)

Correspondence Address: BROWDY AND NEIMARK, P.L.L.C.;624 NINTH STREET, NW, SUITE 300, WASHINGTON, DC, 20001-5303, US

(73) Assignee: Antera Biotech Corp., Taichung-City (TW)

(21) Appl. No.: 11/700,071

(22) Filed: Jan. 31, 2007

(30) Foreign Application Priority Data
Jun. 15, 2006 (TW) 95121493

(51) Int. Cl. B01F 11/00

(52) U.S. Cl. 366/208

(57) ABSTRACT

A shaking mixer includes a first transmission rod set, a first driving motor for rotating the first transmission rod set; two first synchronous transmission members respectively spacedly coupled to the first transmission rod set for synchronous movement upon rotation of the first transmission rod set, a second transmission rod set, a second driving motor for rotating the second transmission rod set, two second synchronous transmission members respectively spacedly coupled to the second transmission rod set for synchronous movement upon rotation of the second transmission rod set, and a moveable platform having two rods arranged in a crossed manner and respectively connected to the first synchronous transmission members and the second synchronous transmission members for oscillation on a plane freely.

### BACKGROUND OF THE INVENTION

1. Field of the Invention

The present invention relates generally to a shaking mixer for reagent mixture and more specifically, to a shaking mixer having a moveable platform that can freely move on a plane.

2. Description of the Related Art

In laboratory, different reagents (either liquefied or powdered) may be mixed for analysis. When wanting to mix reagents, prepared reagents are carried to a mixing container, for example, a reagent reaction container or vitro, and then the mixing container is placed on a centrifugal mixer or shaking mixer, and then the mixer is shaken to mix the reagents.

A conventional shaking mixer has a moveable platform for carrying a mixing container, a driving mechanism controllable to selectively reciprocally move the moveable platform in X-axis, Y-axis, or Z-axis direction. Because the shaking mixer can only move the moveable platform in one direction at a time, it cannot provide a well mixing effect. Further, the moveable platform may be biased or inaccurately displaced, resulting in an incomplete mixing result or damage of the instrument.

### SUMMARY OF THE INVENTION

The present invention has been accomplished under the circumstances in view. It is one objective of the present invention to provide a shaking mixer, which is controllable to oscillate a moveable platform thereof on a plane freely.

To achieve this objective of the present invention, the shaking mixer comprises a first driving motor; a first transmission rod set rotatably coupled to the first driving motor; two first synchronous transmission members respectively coupled to the first transmission rod set for synchronous movement upon rotation of the first transmission rod set; a second driving motor; a second transmission rod set rotatably coupled to the second driving motor and extending along a direction perpendicular to an extending direction of the first transmission rod set; two second synchronous transmission members respectively coupled to the second transmission rod set for synchronous movement upon rotation of the second transmission rod set; and a moveable platform having two first opposite sides respectively connected to the first synchronous transmission members and two second opposite sides respectively connected to the second synchronous transmission members, thereby the movable platform can be freely moved on a plane by the actuation of the first and second synchronous transmission members.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a perspective view of the shaking mixer according to a preferred embodiment of the present invention;

FIG. 2 is a schematic drawing illustrating that the moveable platform can be leftwards and rightwards moved on a plane;

FIG. 3 is a schematic drawing illustrating that the moveable platform can be upwards and downwards moved on a plane;

FIG. 4 is a schematic drawing illustrating that the moveable platform can be moved along a circle path, and

FIG. 5 is a schematic drawing illustrating that the moveable platform can be moved along an oval path.

### DETAILED DESCRIPTION OF THE INVENTION

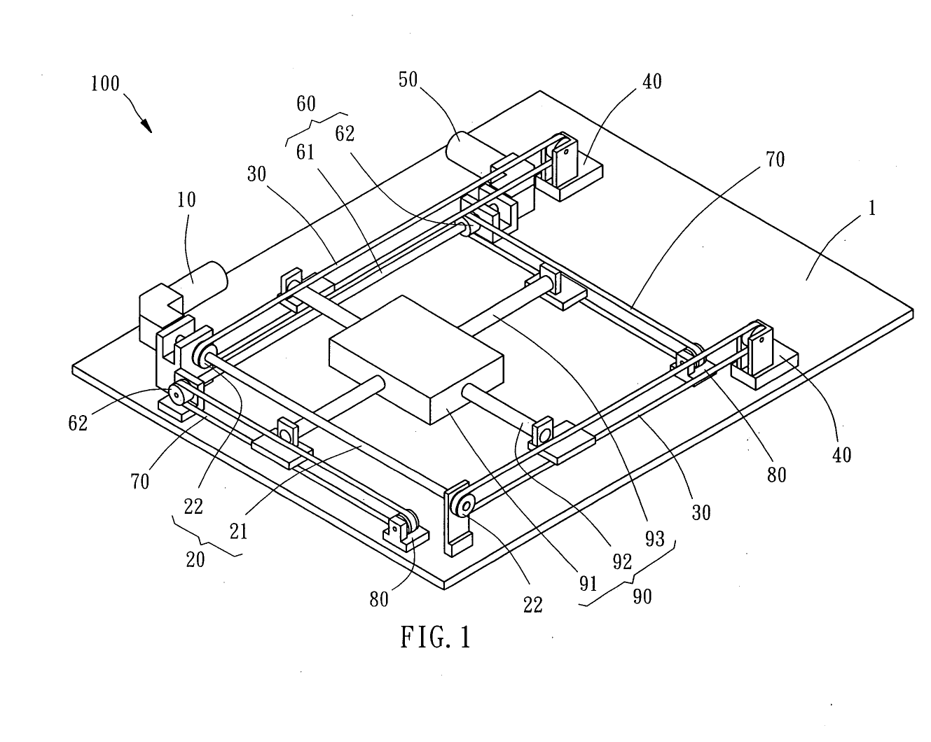

As shown in FIG. 1, a shaking mixer 100 in accordance with a preferred embodiment of the present invention comprises a first driving motor 10, a first transmission rod set 20, two first synchronous transmission members 30, two first tension-adjusting members 40, a second driving motor 50, a second transmission rod set 60, two second synchronous transmission members 70, two second tension-adjusting members 80, and a moveable platform 90.

The first driving motor 10 is fixedly mounted on a base plane 1 of an instrument (not shown) and controlled to output a rotary driving force.

The first transmission rod set 20 comprises a transmission rod 21 and two gearwheels 22. The transmission rod 21 is rotatably supported on the base plane 1 and connected with its one end to the first driving motor 10. Therefore, the transmission rod 21 is rotatable on its own axis by the first driving motor 10. The two gearwheels 22 are respectively affixed to the transmission rod 21 near the two distal ends of the transmission rod 21 for synchronous rotation with the transmission rod 21.

The first synchronous transmission members 30 are toothed transmission belts respectively meshed with the gearwheels 22 of the first transmission rod set 20 for synchronous rotation with the gearwheels 22.

The first tension-adjusting members 40 are respectively mounted on the base plane 1 and respectively spaced apart from the gearwheels 22 at a distance and respectively coupled to the first synchronous transmission members 30 to control the tension of the respective first synchronous transmission member 30. By means of adjusting the positions of the first tension-adjusting members 40 relative to the gearwheels 22, the tension of the respective first synchronous transmission member 30 is relatively adjusted to ensure synchronous rotation of the gearwheels 22 with the first synchronous transmission members 30.

The second driving motor 50 is fixedly mounted on the base plane 1 and controlled to output a rotary driving force.

The second transmission rod set 60 comprises a transmission rod 61 and two gearwheels 62. The transmission rod 61 is rotatably supported on the base plane 1 and connected with its one end to the second driving motor 50. Therefore, the transmission rod 61 is rotatable on its own axis by the second driving motor 50. Further, the extending direction of the transmission rod 61 of the second transmission rod set 60 is perpendicular to the extending direction of the transmission rod 21 of the first transmission rod set 20. The two gearwheels 62 are respectively affixed to the transmission rod 61 near the two distal ends of the transmission rod 61 for synchronous rotation with the transmission rod 61.

The second synchronous transmission members 70 are toothed transmission belts respectively meshed with the gearwheels 62 of the second transmission rod set 60 for synchronous rotation with the gearwheels 62.

The second tension-adjusting members 80 are respectively mounted on the base plane 1 and respectively spaced apart from the gearwheels 62 at a distance and respectively coupled to the second synchronous transmission members 70 to control the tension of the respective second synchronous transmission member 70. By means of adjusting the position of the second tension-adjusting members 80 relative to the gearwheel 62, the tension of the respective second synchronous transmission members 70 is relatively adjusted to ensure synchronous rotation of the gearwheels 62 with the second synchronous transmission members 70.

The moveable platform 90 comprises a platform base 91, a first connecting rod 92, and a second connecting rod 93. The first connecting rod 92 is slidably inserted through the platform base 91, having two distal ends respectively extending out of two first opposite sides of the platform base 91 and respectively coupled to the first synchronous transmission members 30. Therefore, rotating the first synchronous transmission members 30 moves the first connecting rod 92 and the platform base 91 in one direction, i.e., X-axis direction. The second connecting rod 93 is slidably inserted through the platform base 91, having two distal ends respectively extending out of two second opposite sides of the platform base 91 and respectively coupled to the second synchronous transmission members 70. Therefore, rotating the second synchronous transmission members 70 moves the second connecting rod 93 and the platform base 91 in one direction, i.e., Y-axis direction.

After understanding of the component parts of the present invention and their relative relationship, the operation of the shaking mixer 100 is described hereinafter.

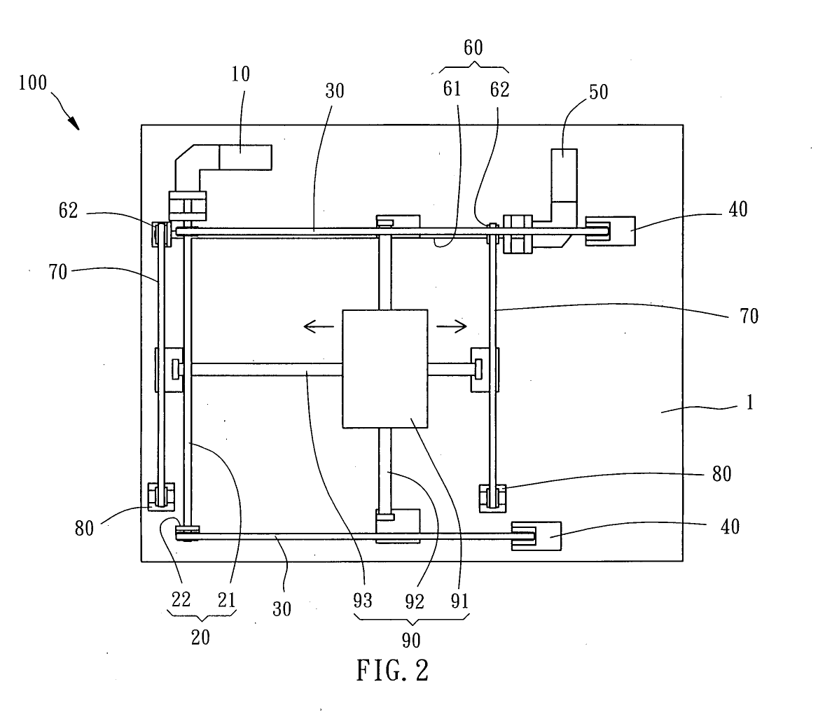

Referring to FIGS. 1 and 2, when the first driving motor 10 is started and controlled to alternate its direction of rotation at a predetermined time interval, the transmission rod 21 of the first transmission rod set 20 is rotated alternatively clockwise and counterclockwise by the first driving motor 10, and thus the first synchronous transmission members 30 are rotated alternatively clockwise and counterclockwise by the first transmission rod set 20 to oscillate the first connecting rod 92 in X-axis direction, and therefore the platform base 91 is oscillated leftwards and rightwards on an imaginary plane above the base plane 1.

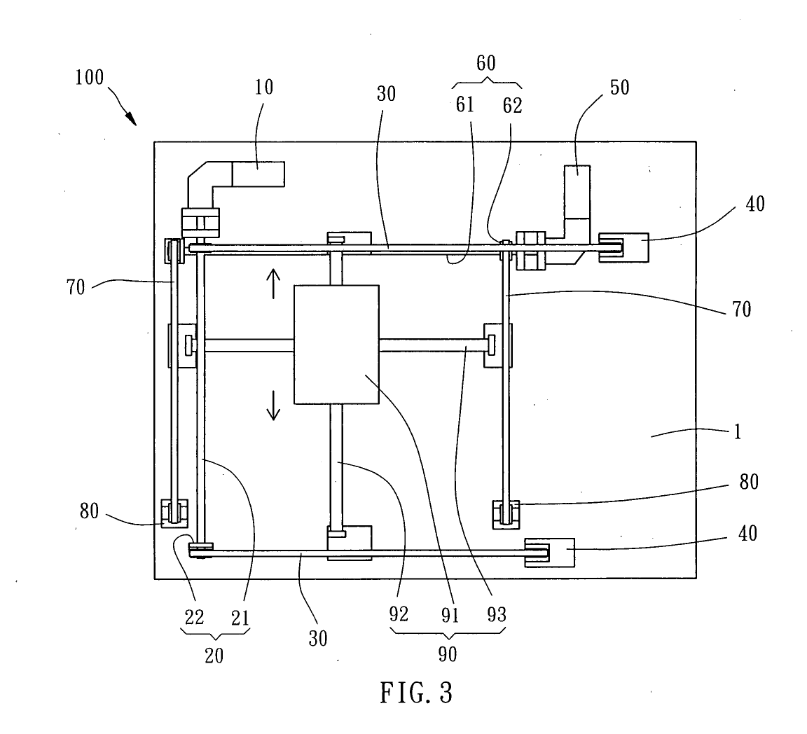

Referring to FIG. 3, when the second driving motor 50 is started and controlled to alternate its direction of rotation at a predetermined time interval, the transmission rod 61 of the second transmission rod set 60 is rotated alternatively clockwise and counterclockwise by the first driving motor 50, and thus the second synchronous transmission members 70 are rotated alternatively clockwise and counterclockwise the second transmission rod set 60 to oscillate the second connecting rod 92 in Y-axis direction, and therefore the platform base 91 is oscillated upwards and downwards on the imaginary plane above the base plane 1.

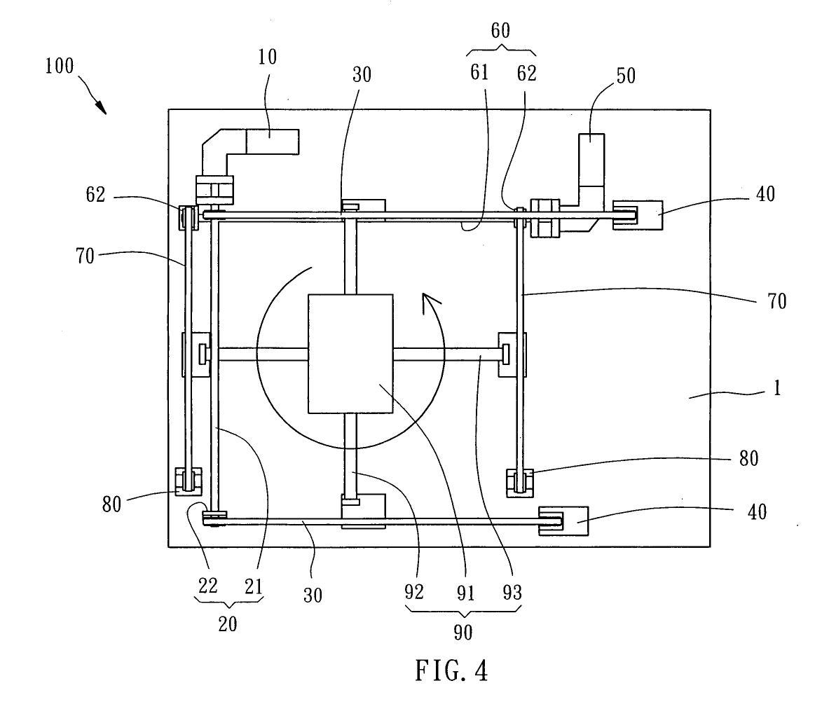

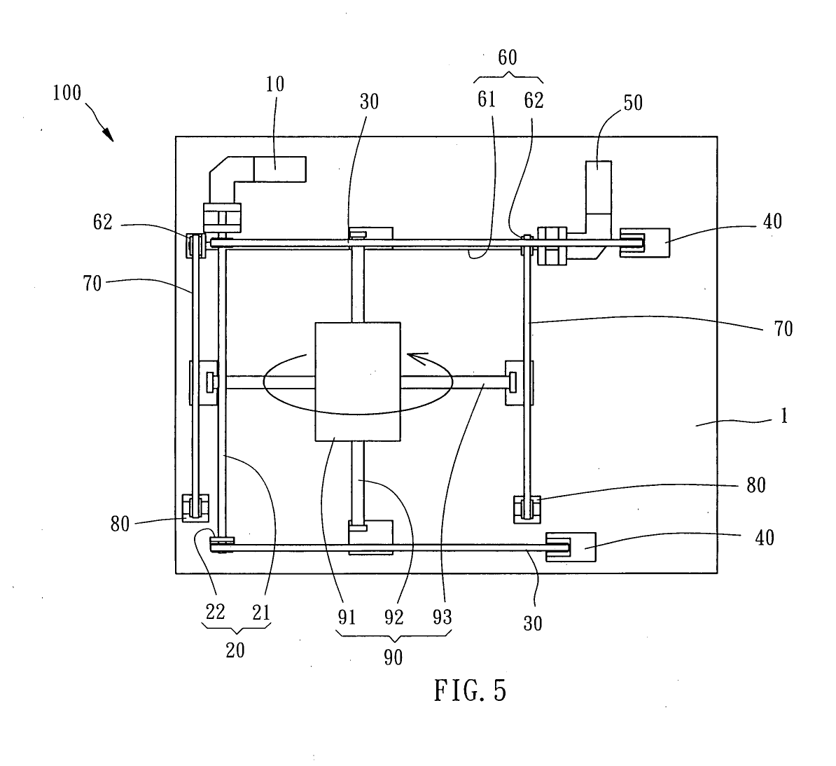

Referring to FIGS. 4 and 5, by means of simultaneously controlling the first driving motor 10 and the second driving motor 50 to rotate alternatively clockwise and counterclockwise, the platform base 91 can be controlled to move along a circular path as shown in FIG. 4 or oval path as shown in FIG. 5. Therefore, by means of controlling the first driving motor 10 and the second driving motor 50 to rotate clockwise and counterclockwise at the same time or to alternatively clockwise and counterclockwise, the platform base 91 can be oscillated freely on the same imaginary plane.

Therefore, by means of controlling the operation of the first driving motor 10 and the second driving motor 50, the platform base 91 can be oscillated in different directions to produce different shaking effects for mixing reagents. Therefore, when a mixing container carrying different reagents is placed on the platform base 91, the platform base 91 can be oscillated in different directions, causing the reagents in the mixing container to be well mixed.

Further, the invention uses the first synchronous transmission members 30 the second synchronous transmission members 70 to move the platform 90 in two different directions, i.e., the first synchronous transmission members 30 are respectively connected to the platform 90 at two opposite sides and the second synchronous transmission members 70 are respectively connected to the platform 90 at the other two opposite sides so that the platform 90 has two opposite sides simultaneously moved in one direction, preventing biasing or inaccurate displacement of the platform 90 due to drawback of driving the platform from one single side.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A shaking mixer comprising:
a first driving motor;
a first transmission rod set rotatably coupled to the first driving motor;
two first synchronous transmission members respectively coupled to the first transmission rod set for synchronous movement upon rotation of the first transmission rod set;
a second driving motor;
a second transmission rod set rotatably coupled to the second driving motor and extending along a direction perpendicular to an extending direction of the first transmission rod set;
two second synchronous transmission members respectively coupled to the second transmission rod set for synchronous movement upon rotation of the second transmission rod set; and
a moveable platform having two first opposite sides respectively connected to the first synchronous transmission members and two second opposite sides respectively connected to the second synchronous transmission members.

2. The shaking mixer as claimed in claim 1, wherein the first driving motor and the second driving motor are fixedly mounted on a same plane.

3. The shaking mixer as claimed in claim 1, wherein the first transmission rod set comprises a transmission rod having one connected to the first driving motor such that the transmission rod is rotatable by the first driving motor, and two gearwheels respectively fixedly spacedly mounted on the transmission rod near two distal ends of the transmission rod and coupled to the first synchronous transmission members for synchronous rotation with transmission rod of the first transmission rod set to move the first synchronous transmission members.

4. The shaking mixer as claimed in claim 1, wherein the second transmission rod set comprises a transmission rod having one connected to the second driving motor such that the transmission rod of the second transmission rod set is rotatable by the second driving motor, and two gearwheels respectively fixedly mounted on the transmission rod of the second transmission rod set near two distal ends of the transmission rod of the second transmission rod set and coupled to the second synchronous transmission members for synchronous rotation with transmission rod of the second transmission rod set to move the second synchronous transmission members.

5. The shaking mixer as claimed in claim 1, wherein the first synchronous transmission members are toothed transmission belts respectively meshed with the first transmission rod set.

6. The shaking mixer as claimed in claim 1, wherein the second synchronous transmission members are toothed transmission belts respectively meshed with the second transmission rod set.

7. The shaking mixer as claimed in claim 1, further comprising two first tension-adjusting members respectively coupled to the first synchronous transmission members for adjusting the tension of the connection between the first synchronous transmission members and the first transmission rod set.

8. The shaking mixer as claimed in claim 1, further comprising two second tension-adjusting members respectively coupled to the second synchronous transmission members for adjusting the tension of the connection between the second synchronous transmission members and the second transmission rod set.

9. The shaking mixer as claimed in claim 1, wherein the moveable platform comprises a platform base, a first connecting rod slidably inserted through the platform base and having two distal ends respectively extending out of two first opposite sides of the platform base and respectively coupled to the first synchronous transmission members for enabling the platform base to be moved in a first direction upon rotation of the first synchronous transmission members, and a second connecting rod slidably inserted through the platform base and having two distal ends respectively extending out of two second opposite sides of the platform base and respectively coupled to the second synchronous transmission members for enabling the platform base to be moved in a second direction perpendicular to the first direction upon rotation of the second synchronous transmission members.
